(19) United States
(12) Patent Application Publication
(10) Pub. No.: US 2006/0071915 A1
(43) Pub. Date: Apr. 6, 2006

(54) Portable computer and method for taking notes with sketches and typed text

(76) Inventor: Peter H. Rehm, Orem, UT (US)

Correspondence Address: Peter H. Rehm, 115 E 900 S, Orem, UT, 84058, US

(21) Appl. No.: 11/243,630

(22) Filed: Oct. 4, 2005

Related U.S. Application Data
(60) Provisional application No. 60/616,343, filed on Oct. 5, 2004.
(60) Provisional application No. 60/631,670, filed on Nov. 30, 2004.

(51) Int. Cl. G09G 5/00

(52) U.S. Cl. 345/173

(57) ABSTRACT

A notebook computer that has a keyboard, a navigation input device (e.g., a touchpad or mouse) and a sketch input device (usually an integrated sketch pad and stylus). The sketch input device operates in an absolute coordinate mapping mode and can be tracked on the display when hovering or touching. It draws digital ink when touching. Whenever the digital ink runs into existing text notes the text is reflowed around the sketch. A movement on an input device can either select text or draw digital ink depending on which input device was used. The computer can have sketch tool buttons operable with a stylus. The navigation and sketch input devices can be disjoint or overlapping. Variations of the sketch input device include a second touch pad that works with a finger and a stylus that works without a sketch pad.

CROSS-REFERENCE TO RELATED APPLICATIONS

This application claims the benefit of U.S. provisional patent applications Ser. No. 60/616,343 filed Oct. 5, 2004 and Ser. No. 60/631,670 filed Nov. 30, 2004.

### BACKGROUND

It is ironic that the so-called notebook computer is not well adapted to taking notes. Most people can type faster than they can write, but when they need to sketch something the notebook computer becomes an awkward tool.

A tablet computer (tablet PC) is a better tool for sketches. A tablet computer is a portable computer that has a writable display screen and usually no keyboard. The writable display screen is sensitive to a stylus (digital pen). This writable display has enough resolution to enable handwriting directly on the display with the stylus. The handwriting and sketches show up as digital ink on the display, immediately under the point at which the stylus touches the display. The handwriting may remain graphical or may be recognized and converted into a character code such as ASCII or Unicode as if it had been typed.

Such tablet computers are well adapted for drawing sketches, but entering text in a freeform, handwritten manner slows the user down. Some tablet computers have a “soft keyboard,” which is a keyboard that is displayed on its screen. However, these keyboards typically are not as fast as touch typing on real keys and do not have the feel of real keys.

Convertible tablet computers also exist. These devices have both a writable display screen and a keyboard. The convertible tablet computer can look and function as a notebook computer. However, the display can also be flipped around and folded down, covering the keyboard with the display facing out, so that it also functions as a tablet computer.

Many tablet computers can be used with a keyboard, either wired or wirelessly. While this is useful for typing in a fixed location, such as at home or in an office, it can be inconvenient to carry a keyboard around for field use, such as carrying it from classroom to classroom.

It is even possible to find a notebook computer that lets you draw directly on the display. However, in normal use, the display of a notebook computer is oriented at an angle that is awkward for drawing small sketches.

It is possible to get accessories for a notebook computer that makes it easier to draw sketches. However, carrying and setting up accessories interferes with portability and convenience.

While all these computers are useful for many purposes, they still do not solve all the problems associated with taking notes in the field on a computer.

### OBJECTS AND SUMMARY OF THE INVENTION

It is an object of the current invention to provide a notebook computer that permits a user to take notes by typing and sketching in real time, integrating text and graphics in a single notes document. It is a further objective to provide a notebook computer that permits a user to type or sketch at will, including conveniently switching between typing and sketching.

Another objective is to provide a version of the invention that works on conventional notebook computers that have a touchpad, and that also allows the current invention's method of drawing and typing into the same document, without the risk of relative/absolute mode confusion.

Another objective of the current invention is to provide a notetaking system that is self-contained, so that a student or other user need only take one item to class (the notebook computer) and to eliminate or minimize the need to set up any peripheral devices such as an external keyboard or graphic tablet.

Another object of the invention is to define how a word processor can be optimized for taking typed notes and drawn sketches.

These and other objects of the invention are met by providing special software and hardware on a portable computer. The software program is a text or word processor that can contain embedded graphics such as sketches, and that is designed to respond to sketching commands by automatically reflowing the text around the sketches. The special hardware is a portable computer that has a second pointing device that is particularly suited to drawing sketches, in addition to the traditional pointing device that is used for navigation.

For users already bound to traditional notebook computers, the second pointing device can be an external peripheral such as a stylus. To keep the invention as self contained as possible, the invention provides for a special stylus that does not require a tablet.

A software-only version of the invention also provides a convenient method of switching a single pointing device between navigation and sketching uses.

Users of the invention can conveniently add callouts to a sketch by clicking and typing. When the callout is finished, the caret (blinking typing point) is automatically returned to its original location.

Existing images and sketches can be enlarged and reduced in size, deleted or relocated with text automatically reflowing around them.

### BRIEF DESCRIPTION OF THE DRAWINGS

FIG. 1 is a top view of a portable computer according to the current invention, showing some notes just before the unique features of the invention are put to use.

FIG. 1A is the portable computer just after and L-shaped line was drawn on the touchpad.

FIG. 2A shows the portable computer just after an L-shaped line was sketched when the invention was in its default mode of operation.

FIG. 2B shows the portable computer just after an L-shaped line was sketched when the invention was in its zoomed-in mode of operation.

FIGS. 3-6 show alternative base members of the current invention.

FIG. 7 shows a pen-shaped stylus that can be used for drawing sketches with the current invention.

FIG. 8 shows an finger cap stylus that can be used for drawing sketches with the current invention.

FIG. 9 is a top view of the portable computer showing two ways the current invention may provide buttons.

### DESCRIPTION OF THE PREFERRED EMBODIMENTS

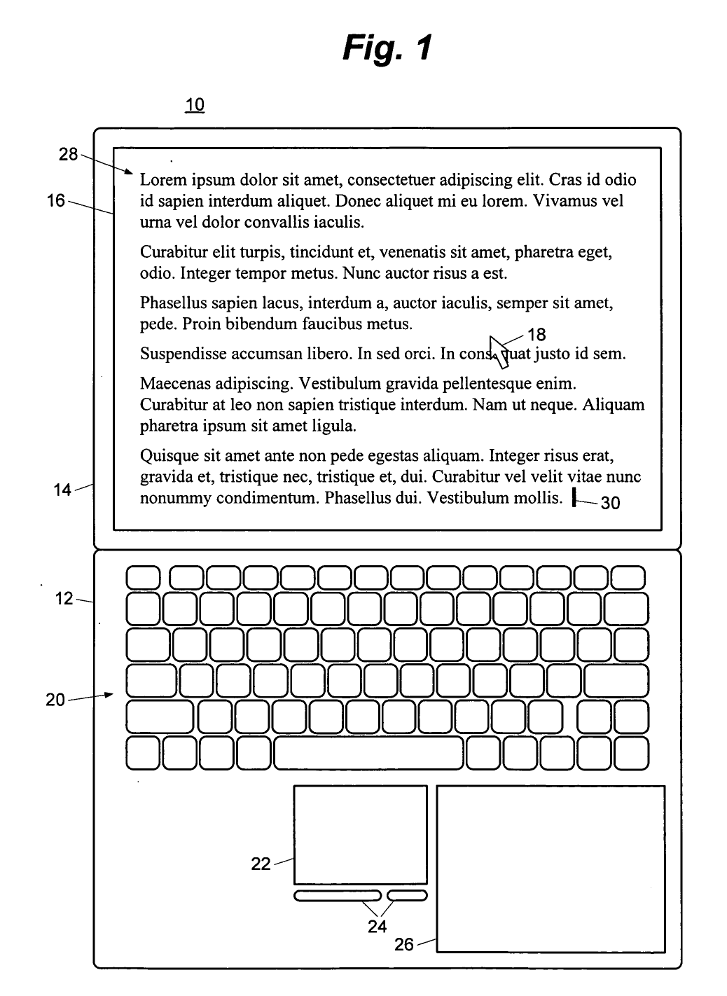

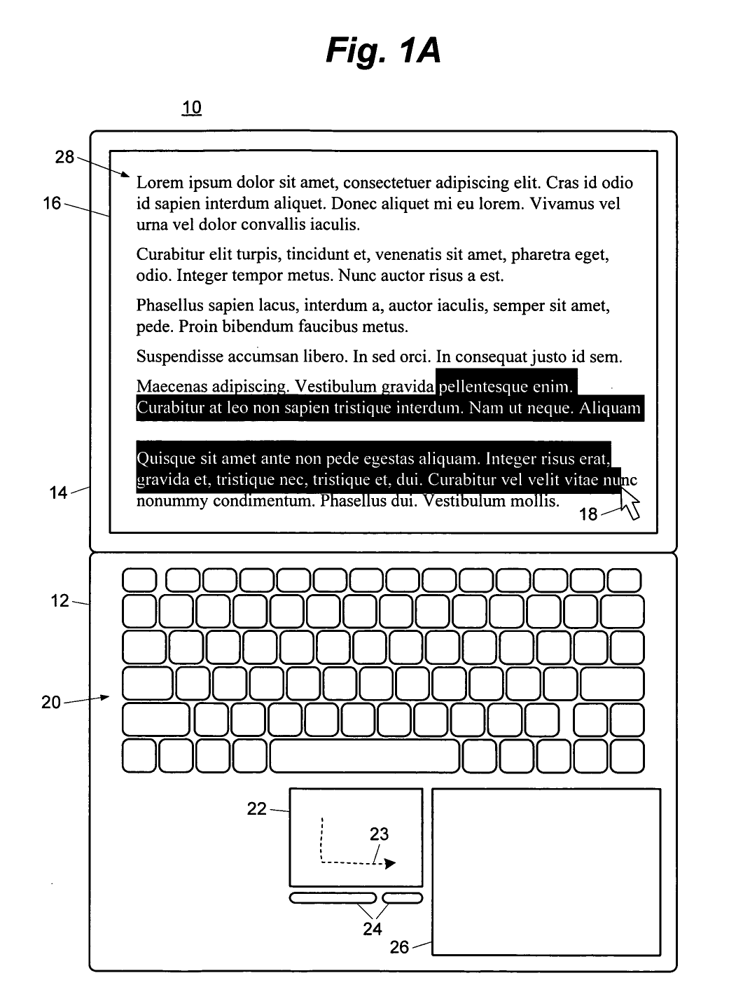

FIG. 1 shows a notebook computer 10 having a base member 12 and a display member 14 that are pivotally connected so that the entire unit can be folded closed. For the current invention, it is sufficient that the unit be a traditional notebook computer with multiple hinges so that it only opens and closes. However, the current invention also permits it to feature a single swiveling pivot so that it can be converted into a tablet computer by covering the keyboard area with the display face-out. Other ways of connecting the keyboard 20 and display 16 are also acceptable.

The display member 14 has a display 16 that occupies most of its surface. The display is showing a cursor 18, some notes 28, and the typically-blinking typing point known as a caret 30.

The base member 12 has a keyboard 20 and a touchpad 22 on its top surface, as is commonly found in notebook computers. The base member 12 also has pointing device buttons 24 that correspond to left and right mouse buttons.

The touchpad 22 is a type of pointing device, which itself is an X-Y input device, meaning that it sends X and Y coordinates to the computer. A touchpad is sensitive the touch of the user's finger in a manner that lets the touchpad input the X-Y position of the user's finger to the computer. It usually is also sensitive to a user's finger merely hovering proximate to its sensitive surface, although hovering activity may or may not be reported to the operating system of particular prior art computers. While it is the most preferred type of pointing device for the current invention, it is not essential that the navigation device be a touchpad 22.

From the user's point of view, the touchpad 22 uses a relative coordinate system. This means that the user does not need to put a finger down at a particular place in order to pick up control of the cursor 18. The user may put down a finger anywhere and that is where control of the cursor 18 originates. Thus the user can move the cursor 18 across the screen in multiple strokes on the touchpad 22. This relative coordinate system makes the touchpad 22 more suitable for navigation than drawing sketches.

It is common to accelerate the cursor movement for fast finger movement so as to minimize or eliminate the need for multiple strokes. This acceleration further disconnects the touchpad's X and Y coordinate system from particular points on the display screen 16.

In the most preferred embodiment of the invention, the base member 12 also has a sketch pad 26 on it. The sketch pad 26 is also an X-Y input device. In its most preferred embodiment, it has the special characteristic that (1) it is sensitive to a stylus and not fingers or hands, and (2) the coordinates on the sketch pad 26 are absolute coordinates (from the user's point of view). The sketch pad 26 is shown on the right, but it may be on the left instead, even if somewhat smaller.

This means that each point on the sketch pad is mapped to or corresponds to a particular point on a sketch. The sketch pad's absolute mapping is not changed as the stylus (or other drawing instrument) draws and skips around within the sketch. For example, when the stylus is picked up off the sensitive surface and taken out of range (so it can not be tracked), the cursor is left stranded at its last location, and when the stylus is placed down elsewhere on the sensitive surface, the cursor immediately jumps to a new position that corresponds to where the stylus came into range again (or where it was placed down).

This feature (absolute coordinate mapping) makes the sketch pad 26 more useful for drawing sketches. For example, the multiple strokes of the previous example would result in several lines drawn nearly on top of one another.

Optionally, the absolute mapping can be changed by explicit zoom or pan commands, but not by mere sketching.

Having a large sensitive area for the sketch pad 26 facilitates drawing sketches. While not an requirement of the current invention, it is preferred that the sketch pad 26 have at least twice the sensitive area of the typical touchpad 22. It is even more preferable that the sketch pad be as large as is reasonable possible with the space available. A convenient way to measure pad size is in keyboard key spacing, from center of key to center of key. Keyboards differ in key spacing according to how much room is available, and pad sizes should reflect this difference. Thus, pad measurements would be reduced proportionately to keyboard size. A typical touch pad measures about three to four keys wide by two to three keys deep. For example, for width, the center of the “Y” key to the center of the “O” or “P” keys; and for depth, the center of the “7” key to the center of “H” or “N” keys. A sketch pad is preferred to measure about six key spaces wide by four key spaces deep, or larger.

It is also preferable that the sketch pad has the same shape (including aspect ratio) as the display. If it does not have the same shape, this is only a problem when attempting to map the entire display to the sketch pad. In that case, in ascending order of preference, either (1) part of the display can be inaccessible from the sketch pad, or (2) the horizontal and vertical pixels per inch can be different, or (3) a portion of the sketch pad that does match the display's aspect ration is mapped to the display and the remaining area is used for special functions such as soft buttons.

The sketch pad 26 coordinate system may, but does not have to have a permanent one-to-one correspondence with the display screen 16. It is preferred that the sketch pad 26 can be mapped to either the full display area or to any subset of the document that is open. Thus, the sketch pad can be mapped to any subset of the display screen 16 area. It is even conceivable that the mapped area could be partially or completely scrolled out of view. Since this is not how it is normally used, the mapped area should be scrolled back into view when the stylus comes in range (or drawing resumes). The sketch pad 26 coordinate system is also subject to zoom and translation. How the open document is displayed, along with its sketches, is to be determined conventionally by view modes, zoom and scroll bars, which are well known in the art.

FIG. 1A shows what happens when an L-shaped line 23 is drawn on the touchpad 22. The result is that a certain amount of text is selected. This is identical to the way many prior art word processors operate and is a feature that is retained in the current invention as well.

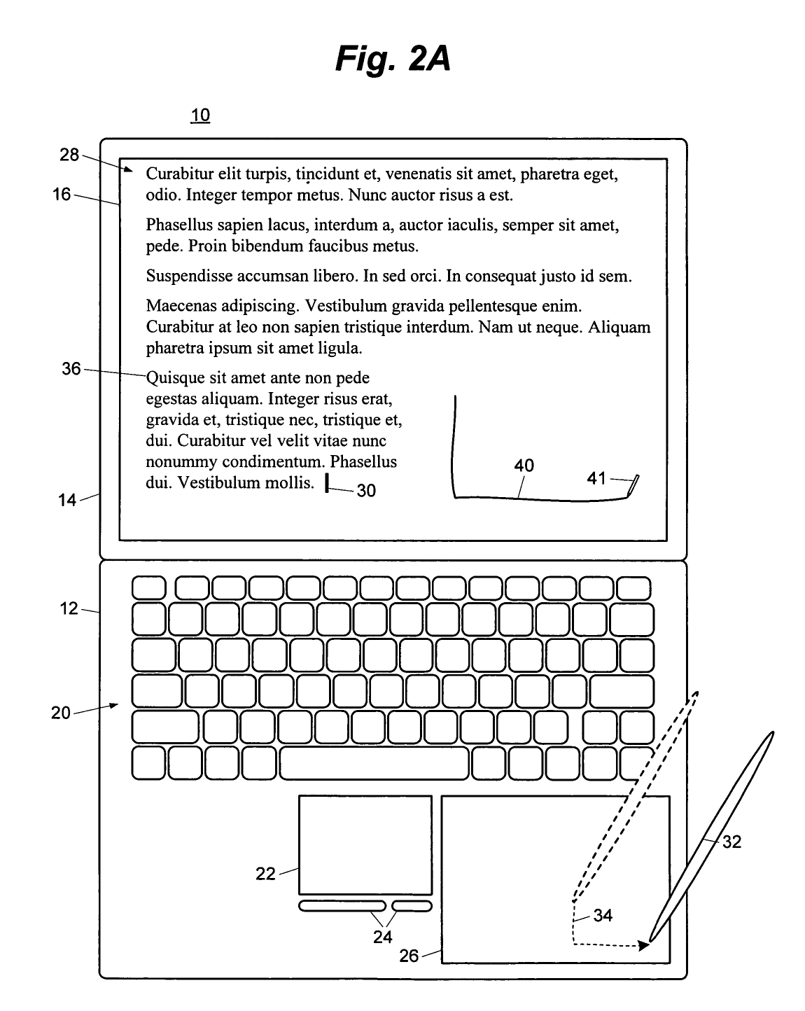

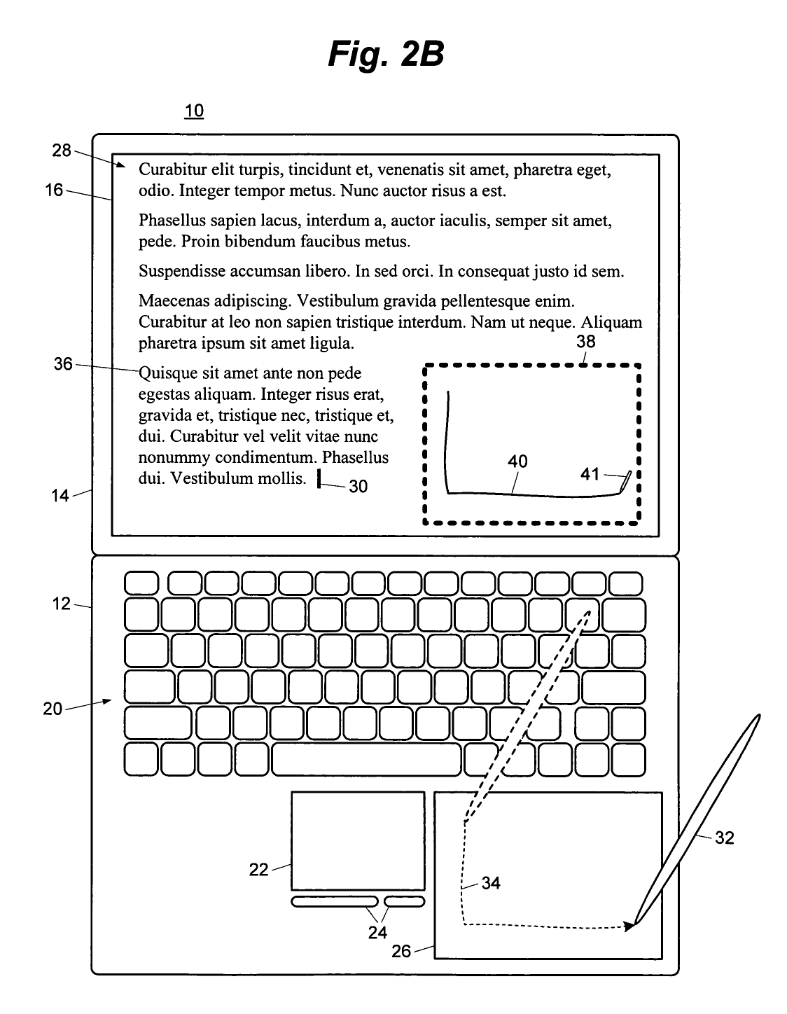

How to Use the Current Invention (Full Screen). FIG. 2A shows an example of how one of the features of the current invention is used in its default mode, with the sketch pad mapped to the entire display. In this example, the document might likely be notes 28 that a student is taking in a college classroom. When the professor explains something important, the student types notes on the keyboard 20. When the professor draws something on the board, the student sketches it on the sketch pad 26.

For example, to draw the beginnings of a graph or chart, the student picks up a stylus 32, puts it down on the sketch pad 26. Because the sketch pad 26 is mapped to the entire screen (absolute coordinates), the student brings the stylus to a place over the sketch pad 26 that approximately corresponds to the desired location of the sketch on the screen. As the stylus gets very near the sensitive surface of the sketch pad 26, its presence is detected and the cursor 41 jumps to the appropriate place. This gives the user feedback before drawing beings. When the user places the stylus on the sketch pad 26, drawing commences and digital ink begins to “flow.” The student then drags 34 the stylus across the sketch pad 26 in an L-shaped manner to arrive at the state of FIG. 2A.

In this full-screen absolute mode, whenever the user sketches anything, the program treats the entire screen as a canvas, even areas containing typed text that are word-wrapped (flowed) under the computer's direction. This is accomplished as follows.

Internally, the invention keeps track of text and graphics much as an ordinary word processor would. Graphics can include images (e.g., photographs), sketches (stored as vectors or bitmaps) and combinations of images with sketches on top of them. Generally, the graphics can be anchored to text so each image appears near the text that pertains to it. The text is word wrapped so as to avoid the graphics. Thus, certain areas of the document are reserved by graphics and the rest is available for text.

For every sketch stroke (e.g., the L-shaped sketch stroke 34), the invention considers whether it falls on an existing graphic or falls in a text area. If on a graphic, it then edits that graphic. If in a text area, then it reserves a sufficiently large area at that point as a graphic and reflows the text around it. If the stroke is over both graphic and text areas, then the area reserved by that graphic is enlarged so as to include the entire stroke. This is true regardless of whether the stroke began or ended on the graphic. If the stroke touches more than one existing graphic, it binds them together into a single graphic.

As the sketch stroke (like 34) is being input, a line (like 40) is drawn in digital ink at the corresponding place on screen. If any part of this line is over text, the text is erased near the line so that it is easy to see the line and its supremacy over the text. When the line is finished, the text is reflowed and repainted on the screen. Preferably, the reflow and repaint are done (1) by a background process or in otherwise idle CPU time and (2) in such a way that the reflow and repaint can be abandoned at any point. The reflow and repaint should be abandoned if a subsequent action of the user makes the results obsolete before they are complete. For example if the user makes a new graphical area and then immediately enlarges it, one final repaint is preferable to two.

It is not normally necessary to indicate to the user where the graphical areas are and where they are not. This will be obvious from the location of the digital ink 40 and the way the text 28 flows around it.

Also, it is not necessary to draw any kind of frame to indicate the absolute coordinate mapping.

Preferably, a new sketch is anchored to a nearby paragraph. The paragraph that had to be reflowed is the first choice. If multiple paragraphs had to be reflowed, then it could be the first, last or a middle paragraph, as preconfigured by the user. Since the caret 30 will often be at the bottom of the screen, the default setting is to anchor a new sketch to the last paragraph that had to be reflowed. (Paragraphs that are merely moved down in the document are not counted as being reflowed.)

Because the sketch pad 26 is much smaller than the display, the user's objects and letters will be enlarged on screen. Thus the user will usually want to draw and write small in one section of the sketch pad. Users that do not like drawing tiny features may switch to a zoomed-in mode of operation.

How to Use the Current Invention when Zoomed-In. FIG. 2B shows how the user would take notes and draw the same example sketch in a zoomed-in mode of the invention. In the zoomed in mode, the sketch pad 26 is not mapped to the entire display 16 screen area. Instead, it is mapped (or ready to be mapped) to a subset of the display screen that represents a portion of the document. This is still absolute coordinate mapping.

To enter zoomed-in mode, the user either gave a zoom command or has preconfigured a zoomed-in size for the sketch pad's absolute coordinate mapping. For example, the user may preconfigured it to be one quarter the size of the screen, one half or one third the width of the document. Additionally, the user may preconfigured it to always place new graphics right-aligned with the document.

According to the current invention, when the note-taking software detects a switch from typing to sketching (e.g., it senses the presence of a stylus), or the user starts sketching without first selecting an existing sketch or image, the note-taking software does the following:

1. It automatically reserves a graphical area of the document for the sketch.

2. It sets up absolute coordinate mapping between the sketchpad and the reserved area.

3. It displays the first line(s) 40 of the sketch in the reserved area.

4. When there is time, it reflows the text so as to avoid the reserved area and repaints the reflowed text.

5. Optionally, it draws a coordinate mapping frame 38 on the display to indicate the area where the sketch pad is currently mapped.

These steps are explained in greater detail below:

1. The Reserved Area. The reserved area is the area that is used by or reserved for a sketch or other graphic. Whether or not the reserved area is a visual element is preferably another user option, preconfigured and switchable in the application's View menu. The default setting is that the reserved area is not a visual element. If the user chooses to make the reserved area visible, it can be done as a light frame around the reserved area or a shading (or contrasting lack of shading) of the entire reserved area.

In FIG. 2B, a coordinate mapping frame 38 is shown. This lets the user see the current drawing boundaries of the sketch pad 26 according to the current absolute coordinate mapping. As shown in this example, the extent of the reserved area happens to match the coordinate mapping frame 38. It should be kept in mind that they do not always match. In other words, the mapped area may be partly reserved and partly not reserved, and text may be reflowed into the part that is mapped but not reserved.

The original size of the reserved area is determined by user option: either a predetermined fixed size (default) or the size of the first line of the drawing. For example, a user may choose to initially reserve half the usable width of the document for a new sketch.

There are certain benefits to initially reserving a predetermined size and making that predetermined reserved area's shape match the sketch pad's shape. First, every time the user starts a new sketch, he has the entire sketch pad's worth of space to use. This helps in planning the sketch and helps reduce situations in which the user must pan the absolute coordinate mapping frame 38 to finish the sketch. Second, the sketches automatically takes up a reasonable amount of space on the document. Third, the user can draw objects and letters in a more natural size.

It helps if the resolution of the sketchpad maps well with the resolution displayed on the monitor when the document is in the most commonly used zoom mode.

The original location of the reserved area is also determined by user option in conjunction with the reflow of text. This is because, preferably, the location of the caret 30 and the size of the current paragraph 36 play a roll.

2. Absolute Coordinate Mapping. Absolute coordinate mapping means not relative coordinate mapping. It does not mean that the mapping can never change. The user can still zoom in or out or pan and thereby set up a different absolute coordinate mapping. Absolute coordinate mapping simply means that the starting point of a stroke on the sketch pad 26 does not change the coordinate mapping . The coordinate mapping frame 38, if visible, does not move either.

3. Display the First Line(s) on the Sketch. The stylus 32 motion 34 that initiated the sketch in the current example is displayed as digital ink line 40 on the sketch. If any lines are on text 28, then enough text 28 is erased to make the lines clearly visible without interference from the text 28. To avoid flicker, only text that must be moved because of reflow is eligible for erasure. Text 28 that does not have to be moved does not interfere because it is already far enough away from the sketch lines.

According to the current invention, the sketch could also have been initiated by depositing any other drawing element on the sketch pad 26, such as geometric shapes, brush strokes, flood-fill paint, etc., or by importing an image or by capturing an image from a connected camera device.

4. Reflow of text. After the current invention has internally reserved an area for the sketch, it must actually reflow the text 28 around it. For best results (good final caret position), the reflow of text should be in at least two parts. The first part is that the reflow is planned to make sure the outcome is acceptable (obeys all the rules herein as best as possible). Preferrably, this first part is done before the position of the reserved area is finalized.

When text is reflowed in response to a change in the reserved area, the two most important rules are that the entire coordinate mapping frame 38 should (or would) be visible and that the caret 30 should be visible. In addition, it is also preferable that the entire reserved area be visible. (The user can scroll these items out of view at will, but that is not reflow of text.)

The remaining default rules are that, vertically, the sketch area should be near the caret 30 (the typically-blinking typing point). The sketch area should not start higher than the first line of the caret's paragraph 36, nor should the caret 30 (after reflow of text) be more than one line below the sketch area. Horizontally, the sketch area is right aligned with the document right margin.

These rules can be modified by user configuration options. For example, some users may prefer that the sketches be left aligned or horizontally centered. Others may always want their sketches below or above the caret 30.

The second part of reflow of text, which tends to take more processor time, is to actually draw the newly reflowed text. To avoid flicker, this is preferrably done on an off-screen bitmap which is then copied to the display 16.

5. The coordinate mapping frame 38. The coordinate mapping frame 38 is an indication on the display of how the sketch pad 26 maps to the document. It is temporary because it lasts only so long as the sketch is selected for drawing. However, the user may type while the sketch is still selected for drawing.

Initially, the coordinate mapping frame 38 will match the initial reserved area. If the user enlarges the sketch (reserves more area) or zooms in or pans, then it will not match the reserved area.

Preferably, whether and how this coordinate mapping frame 38 is indicated is a user-controllable view option, configurable in advance in a user preferences area and also switchable from a “View” menu.. For example, the user can control thickness of the frame, its color, darkness, and transparency, how long it remains in place, as well as whether it shows up at all.

The coordinate mapping frame 38 is optional because the invention can be used without it. When the stylus 32 hovers over the sketch pad 26, a sketch cursor 41 appears, showing where the stylus 32 is in relation to the sketch. The sketch cursor 41 follows the movements of the stylus 32, so long as the stylus 32 is on or near the sketch pad 26. Drawing occurs only when the computer perceives that the stylus 32 is in contact with the sketch pad 26, or the user otherwise causes digital ink to flow.

The sketch cursor 41 has a variable icon. In FIGS. 2A-2B it is shown looking like a pencil, which indicates to the user that a pencil-like drawing tool is active. Other drawing tools and sketch cursor icons that can be activated by the user include, in order of importance: an eraser, flood-fill, cross-hairs or arrows for selection, selection rectangle or lasso, brushes, geometric tools such as ellipses and polygons, an air brush, and other tools common in the art of computer graphics programs.

How the coordinate mapping frame 38 is drawn is a matter of design and user choice. In FIG. 2B the coordinate mapping frame 38 is shown as a dashed line, preferrably animated so it appears to rotate around the mapped area. Other ways could include dimming all areas displayed that are not mapped to the sketch pad, so as to focus attention to the mapped area which is not dimmed. Another option is to transparently shade a thick rectangle around the mapped area. The mapped area should be contained within the inner edges of the coordinate mapping frame.

If the current invention is set up to initially reserve a drawing area of a predetermined fixed size, it is preferred to show the coordinate mapping frame 38. In other words, by default these two options go together. When the user returns to typing or otherwise deselects the sketch, the coordinate mapping frame 38 is removed.

Sometimes the preconfigured reserved area will turn out to be excessively large for a particular sketch. Therefore, when a sketch is deselected, it is examined to determine whether there are any significant unused parts of the reserved area that could be returned to the text. If so, these unused parts are trimmed (i.e., unreserved) and made available to text, which is then reflowed to take advantage of the return of some space. Another user configuration controls whether the entire sketch can be shifted towards the right (or left) margin if that is where the unused reserved parts were located.

If the current invention is set up to initially reserve a drawing area based on the size of the first line(s) of the sketch, then it is preferred to not show the indication of sketch pad mapping. (This is the other side of the default connection between these two options. However, the user may override these connections.) The advantage of this “no indication” mode is that the process of sketching appears to be simpler and less busy. Nevertheless, if the user is panning or zooming the mapping of the sketchpad, the invention should at least temporarily indicate where the sketch pad is mapped.

Selecting an Existing Sketch. The user can select an existing sketch by clicking on it with the touchpad 22. When selected, various drawing tools appear nearby for selecting different pen colors, pen tips or brushes, erasers, objects such as circles and rectangles, etc. These types of on-screen tools are well known in the art. Thus the user modifies the selected sketch by drawing or erasing the digital ink. Tools also appear that enable the user to move, shrink or blow up the sketch on the document. If necessary, the text reflows around the new boundaries of the modified sketch.

During sketching, the user is presented with controls for zooming and panning, changing color, pencil and eraser, and other drawing tools such as are common in graphic design software. These controls may be provided in a floating tools window that can also be docked to an edge, if the user desires. The tool is floating because it can be relocated with the touchpad 22 and it always stays on top of the document.

As an alternative to consuming display space for such tools, the notebook computer 10 could also be provided with flat buttons to the left of the touchpad 22. These buttons would not be susceptible to being pressed by the heel of the user's left hand, but can be pressed by either the users left fingers while drawing or by the stylus.

When the user selects a sketch, if the document is too zoomed out to make drawing practical, then the software should automatically zoom the document in enough to make the sketch and the coordinate mapping frame (whether or not shown) a practical, useable size. Zoom (or coordinate mapping zoom) is different from the document zoom.

If the user zooms in, then the coordinate mapping frame 38 is restricted to a portion of the sketch. If necessary, the sketch may be enlarged so that the coordinate mapping frame 38 remains a good workable size, considering the resolution of the sketch pad 26.

If the user pans, it means that the coordinate mapping frame 38 is shifted vertically or horizontally, and may overlap an area that is not part of the reserved area. In the latter case, the current invention may behave in one of two ways: (1) immediately extend the reserved area and reflow the text, or (2) wait until the user draws on this unreserved area (e.g., draws a line into the text) and then extend the reserved area and reflow the text.

There are other situations in which a coordinate mapping frame 38 extends beyond a sketch, such as (1) when the document is zoomed out a little but not enough to trigger a zoom change on sketch selection or (2) when a small sketch was trimmed down and now doesn't fill the coordinate mapping frame 38. In such cases, the sketch can be enlarged by drawing beyond its current boundaries, even if this takes digital ink into the text 28 area. The software responds by enlarging the reserved area and reflowing the text around the new reserved area. All of this happens automatically so the user perceives only that it is possible to draw anything anywhere.

Camera. Optionally, the notebook computer is also equipped with a camera. Preferably this camera has at least a million pixels of resolution and zoom capability. The purpose of the camera is to capture chalkboard writing, demonstrations, slides, and anything else found in presentations. The camera should either be mounted the top of the display (facing out) or it should be removable from a mounting and held up for taking pictures, or mounted on a telescoping holder, or any combination of these. The preferred place for the camera is in a receptacle slot in the base member 12. The camera has its own rechargeable battery which is kept recharged when the camera is in its receptacle. At least when it is removed from its receptacle, the camera can be used to take still pictures. The camera can communicate with the notebook computer in one of several ways: (1) Preferably, it transmits images continuously and wirelessly, (2) it transmits images continuously over a fine retractable wire, or (3) it holds still images until it is replaced in its receptacle, and then it downloads them. The continuous transmission of images does not need to be at full resolution. Just enough to position the camera is sufficient. Enough resolution for short video clips would also be useful. The communication methods can be combined with the camera transmitting continuous video at video conference resolution (e.g., 320 by 240 pixels) and then download still images when it is replaced in its receptacle.

Photographs. If a digital photograph is selected and the user draws on the sketch pad, the photograph becomes the background of the sketch. This permits the user to import or capture images and annotate them with sketches.

Annotating Sketches with Callouts. Sketches can be annotated with typed text as follows: The user picks up a “callout tool” and clicks on a point in the sketch with it. This callout tool can be accessed either (1) as a drawing tool Oust like the pencil, brush, or eraser tools) or (2) by double-clicking with the navigation pad 22 or the sketch pad 26. The exact behavior of these options, which are enabled or disabled and number of clicks required, should be controllable by user configuration options.

The current invention responds to a callout tool click by drawing a callout line from the click point to the closest available blank area of sufficient size. This may be inside the reserved area but if outside then the reserved area is enlarged. A caret (blinking typing point) appears near the other end of the callout line. Any text that is typed becomes part of a callout label. This callout label expands to take up more width and more lines as more text is typed. A navigation click, sketch line or the Enter key terminates typing in the callout label.

The callouts are under control of the current invention such that the label portion can be relocated to make room for other callout labels or additions to the sketch. Of course, the invention does not on its own change the click point where a callout points.

The callout label text can be modified by clicking in it with the touchpad 22 or other navigation device. Callouts may be manually rearranged by clicking on them and dragging them to their new location. The user may also move the click point where a callout points.

The callout lines connect the callout labels and the original click point in the sketch. These lines should be fine and may be dashed, dotted, reverse color or tinted so as to not interfere with comprehension of the sketch. The user can select one or more by using the navigation device and can delete them by pressing the delete key.

During sketching the caret 30 is not moved in the document. Even creating and editing callouts does not cause the document caret to be moved, though this will temporarily suspend blinking of the document's main caret 30 while a callout caret is active and blinking.

The Navigation Device can Access Objects within a Sketch. In general the touchpad 22 or other navigation device (any X-Y input device that is not the sketch pad 26) is used to select and access images and sketches as objects, and to access the individual objects within the sketches, including callouts. The sketch pad 26 is used not for accessing objects, but for actual sketching and picking tools. The sketches themselves may be stored as bitmaps or vectors. If they are stored as vectors, the navigation device may also be used to access and modify individual elements (lines, etc.) of the sketch as well, but preferably only after the user executes a command to open a sketch to enable that level of access and modification.

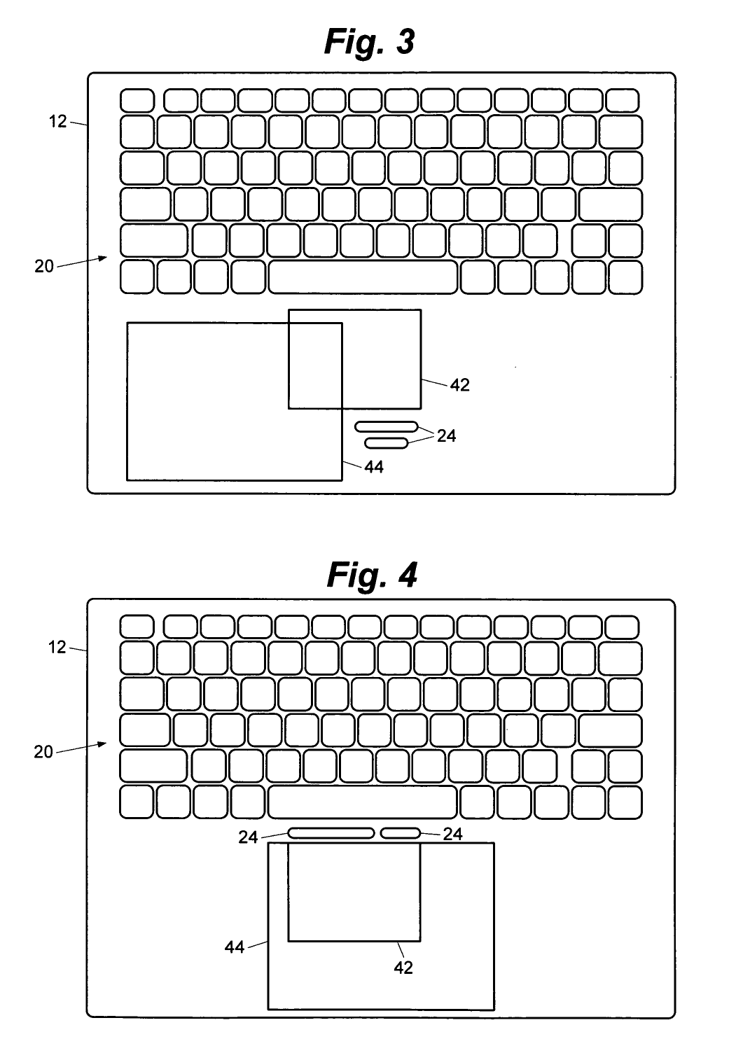

Overlappable X-Y Input Devices. FIG. 3 shows a modified version of the invention (base member 12 only) having an overlappable touchpad 42 and an overlappable sketch pad 44 that partially overlap. The overlappable pads may or may not operate under different principles of detection, as will be explained later. While overlapping pads can be used in many arrangements, they are particularly useful in a version of the invention that is adapted for left-handed people. This is because touchpads are usually located a little left of center, leaving less space available to their left. The pointing device buttons 24 are positioned to not interfere with the sketch pad 44 and yet be convenient to the user.

FIG. 4 shows another modified version of the base member 12 of the invention, this one having the overlappable touchpad 42 contained within or enclosed by an overlappable sketch pad 44. In other words, the overlappable touchpad 42 is 100% overlapped. This version of the invention can be conveniently used by left-handed or right-handed people.

When these pads overlap, their boundaries should be visible to the user. In the event it is not obvious from the structure of the pads themselves, indicia should be used to indicate where they are.

If these two pad are both 100% overlapped to each other, so that they are both in the same place and of the same size and shape, then it is a dual-sensitive touchpad. This is a touchpad that is sensitive to both a finger and a stylus, but separately so. Being separately sensitive to a finger and a stylus means that the computer can tell whether it is a finger or a stylus that is the cause of X-Y inputs. A finger is used for navigation and a stylus is used for sketching.

Keyboard Cursor Control Stick. FIG. 5 shows still another modified version of the base member 12 of the invention in which there is no traditional touchpad and the notebook computer relies on a keyboard cursor control stick 46 for navigation. The sketch pad 26 does not share any of its sensitive area with any touchpad.

In any of the variations of the current invention, a mouse or other pointing device can also be connected to the computer to supplement or replace the touchpad 22. Any action that can be taken with the touchpad (used for navigation) in the current invention can also be taken by another pointing device that is provided for navigation.

In FIGS. 3 and 4, the overlappable touchpad 42 and overlappable sketch pad 44 need to be able to tell whether they are being used for navigation or sketching. Additionally, in all embodiments of the invention that have a sufficiently large sketch pad, when the user is typing the sketch pad will generally have a hand or wrist resting on it or proximate to it. If the sketch pad is sensitive to fingers and hands, it could generate extraneous X-Y inputs. The current invention usually needs to be able to tell when the user is sketching so it does not process extraneous X-Y inputs improperly.

Distinguishing touchpad and sketch pad inputs. The current invention can distinguish sketching from navigation and typing (wrist resting) in any of the following ways:

1. Using a touchpad 22 and finger for navigation and a stylus and sketch pad (26,44) for sketching. The touchpad (22,42) is sensitive only to fingers and the sketch pad (26,44) is sensitive only to a stylus. This is the most preferred because it is unambiguous to both the user and the current invention. The touchpad and sketch pad can be one dual-sensitive toughpad (which looks just like FIG. 6).

2. If using a sketch pad that is sensitive to body parts, requiring the user to switch between navigation and drawing modes. This can be as simple as providing a menu item or a soft button (a button drawn on the display) to click on or having the user to hold down a key while sketching. If done by key, preferably this is a special key, key combination or physical button that is not used during normal typing. For example, the user would hold down both the Ctrl and Shift keys to indicate a sketch is coming, or hold down Ctrl and press Caps Lock to enter a sketching mode that lasts until any other key (including Caps Lock again) is pressed. This allows a single touchpad to be used for both navigation and sketching.

3. If using a sketch pad that is sensitive to body parts, attempting to detect whether or not the user's sketching hand is in a typing position. If it is, then ignore X-Y inputs from the sketch pad area. If it is not in typing position, then accept X-Y inputs from the sketch pad. If the user's preferred hand is not known, then both hands must be on the keyboard for the sketch pad's X-Y inputs to be ignored. If the navigation pad and sketch pad overlap then these tests also determine whether X-Y inputs from the overlapping area are treated as navigation commands or sketches. This way of distinguishing is the least preferred because the user's hand position can be difficult to detect reliably and it is somewhat subjective, restricting and unpredictable to the user. It does not matter to the invention how it detects whether or not the user's hand is in a typing position. A few ways to detect this include: (1) light detectors on the keyboard with and without cooperating light sources above the display, (2) light sources and sensors under the users hands attempting to detect reflected light, (3) body capacitance, (4) IR heat sensors, (5) electrical fields picked up by the user acting as an antenna, etc. The above ways that use light may use visible or invisible light, and constant or modulated light.

4. Examining the nature and clarity of the signals from the sketch pad to determine whether they have pinpoint precision (as in drawing) or blanket generality (as in a wrist resting). Many touch-sensitive pads operate by continually measuring the capacitance at each intersection of X and Y grid wires. When a body part is close, the capacitance goes up. Thus, drawing signals (the relatively sharp point of a single finger) can be filtered out from extraneous noise. This filtering can be done in one or more integrated circuits that control the touch pad so as to not burden the CPU.

If the stylus-way of distinguishing sketching is not used, then the traditional touchpad (for navigation use) and the sketch pad can use the same touch pad (i.e. finger-sensitive) technology. The pads can be separate, but overlapping them is easy: the sketch pad may be overlaid or may just be a continuation of the navigation pad. It is preferred, however, that the navigation pad still be limited to its traditional size and location because that is where users expect it (for use by thumbs) and more importantly because that area is not subject to hands and wrists resting on it.

If the stylus-way of distinguishing sketching is used and the pads overlap (as in FIGS. 3 and 4), then the pads preferably detect a finger and a stylus separately, using different technologies. For best results, modes of detection that would interfere with one another should take turns many times a second so that both appear to the user to be continuously active at the same time.

The most preferred embodiment of the invention is shown in FIG. 1, in which the navigation pad 22 uses touch pad technology and the sketch pad 26 is separate and uses a stylus technology that is insensitive to fingers and hands. This embodiment of the invention is both simple to manufacture and intuitive to the user. Of course, the invention should also have a stylus holder somewhere, the exact location being a matter of design.

When the user draws sketches with a stylus, the presence of the stylus barely above the sketch pad can be detected and its location should be shown on the display. When the stylus is in the air just above the sketch pad, its location is tracked without drawing any digital ink. This helps the user control where to put the stylus down. With this feature of the sketch pad and display, it is fairly easy to develop eye-hand coordination even though the display and sketch pad are in separate places. Once the stylus is down, drawing starts and digital ink “flows.” Sketching involves frequently picking up and putting down the stylus. Thus, the process of sketching is very natural and intuitive to the user, with the stylus behaving like a pen or paintbrush. It draws when down and does not draw when up.

Some stylus and X-Y input device technologies cannot actually tell whether the stylus is touching its pad, but guess based on whether their measured proximity crosses some threshold. While a user can get used to this, it is preferred that the sketch pad actually be able to detect contact. This can be accomplished several ways including closing a debounced switch upon contact, the switch altering the stylus's resonant frequency, among other ways.

Preferably, the sketch pad can also sense the pressure of the stylus. The pressure information is used to determine how dark and/or thick the digital ink is. Pressure can be used in other ways as well. For example, if the user picks up a different drawing tool, such as an airbrush, the pressure can determine the intensity of the spray or the closeness of the spray to the digital subject. Some users may be annoyed when the invention responds to stylus pressure differences, so whether the invention uses pressure to alter the flow of digital ink is another user configuration option.

Relative Mode Sketching. Some users may have a difficult time with absolute coordinate mapping if they are very used to the relative interpretation of touch pads. Also, if the user uses a mouse to draw sketches, the difference between relative coordinate mapping and absolute coordinate mapping largely disappears until the mouse is picked up and moved. Thus, to avoid customer confusion, and to make sure the invention is usable under all circumstances (including with a mouse) the invention may provide for a user preference option that eliminates the absolute coordinate mapping mode, even when drawing sketches.

A consequence of drawing sketches in a relative coordinate mapping mode (or “relative mode) is that line drawing occurs differently: digital ink flows only when a pointing device button is held down. The left and right buttons can be assigned different meanings, such as different colors or a color and an eraser. If neither button is pressed, movements are shown on the display without any digital ink being drawn. This method of drawing works especially well with mice, since these are not often removed from their mouse pads. If a sketch is drawn in relative mode, the user would typically keep a finger or stylus on the pad for most or all of the sketch, using the left and right pointing device buttons to control the flow if digital ink. Because of the relative coordinate system, picking up the drawing finger or stylus and placing it down elsewhere is the equivalent of panning and can be done to enlarge the sketch or draw on a different part of it.

When drawing sketches in relative mode, it is less useful and more difficult (than in absolute mode) to indicate the extent of a reserved area or mapping on the display. Thus, this feature need not be available for relative mode. Another user preference setting (applicable only when relative mode sketching is enabled) is the extent to which pointing device acceleration is practiced. The default is that it is practiced to the same extent as for navigation pointing device movements, so as to not surprise the user.

Single Pad. FIG. 6 shows another embodiment of the invention. This one has a solitary touchpad 48 that is used for both navigation and sketching. Preferably its about 50% larger in sensitive area than typical traditional touchpads on notebook computers, but even a small X-Y input pad would work. (If a split keyboard is provided then the solitary touchpad could be 100% or more larger without causing problems with accidental inputs.) The user explicitly switches between navigation and sketching modes as described above. An additional pointing device such as a mouse may be useful but is optional.

Standard Notebook Hardware Embodiment. The embodiment of FIG. 6 shows that with some inconvenience due to a small sketch area, the current invention can be practiced on a traditional computer, including a traditional notebook computer with a touchpad. Such a “standard hardware” embodiment of the invention requires no hardware change at all. In this standard hardware embodiment, the same (one and only) touch pad (or any other pointing device) is used for both navigation and drawing sketches.

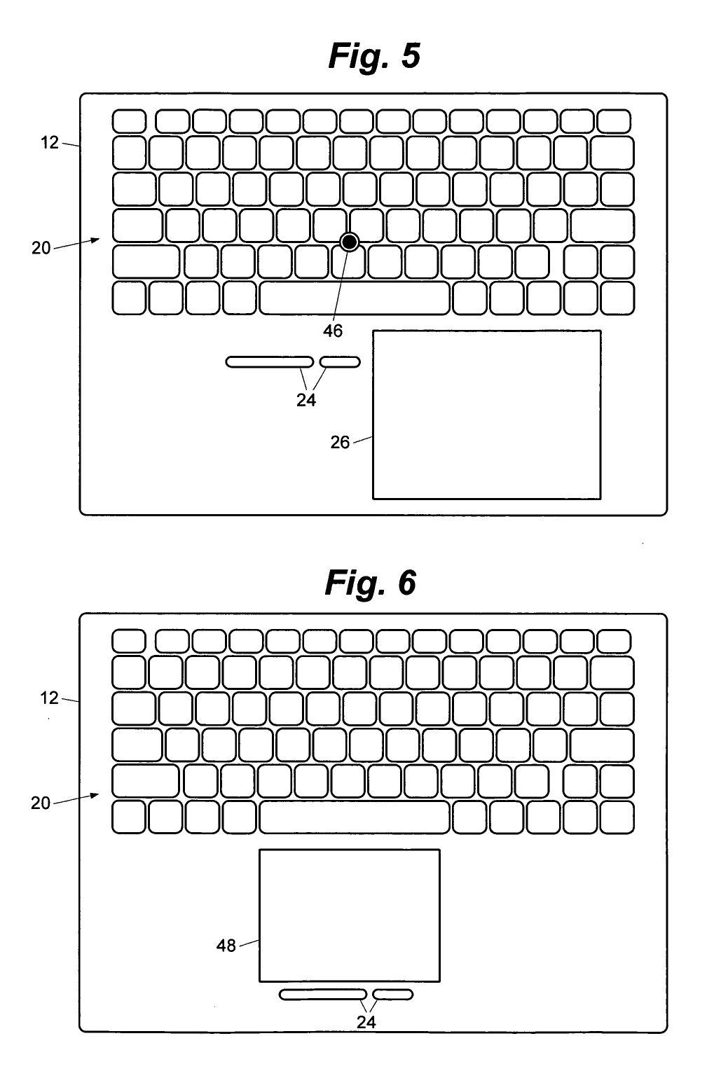

The Stylus. FIG. 7 shows a stylus 50 suitable for use with the current invention. This type of stylus is shaped somewhat like a pen or pencil. It is of the type that has become common with tablet PC and graphic tablets. Also, as has become typical with tablet PC's, the stylus 50 can be inserted into a stylus holder somewhere on the notebook computer 10. The exact location is a matter of design and available space.

The stylus 50 as shown is wireless and may be used wirelessly. Nevertheless, it has a loop 52 on it. A user may tie a string 54 to the loop and the notebook computer 10 to keep the stylus from getting lost. Alternatively, the stylus may be wireless with no loop or wired, it does not matter to the invention except for the eraser tip.

The stylus can be turned over so that the upper end touches the sketch pad. This upside-down use of the stylus results in an eraser action being performed by the invention, just as with a pencil. The user can trade eraser for any other tool, but the top end of the stylus defaults to an eraser.

If the stylus has any kind of cord on it, it becomes less convenient to turn it over for erasing. That is why the loop 52 is the preferred compromise. The loop should be small enough that it does not prevent upside-down operation of the stylus. Whether the string 54 is used is up to the user. The erasing function will be available with or without the string 54 attached. Of course, an erasing function can also be accessed from the tool bar without turning the stylus upside-down.

The presence of stylus can be detected by the sketch pad. It does not matter to the invention whether this is done with an active or passive stylus.

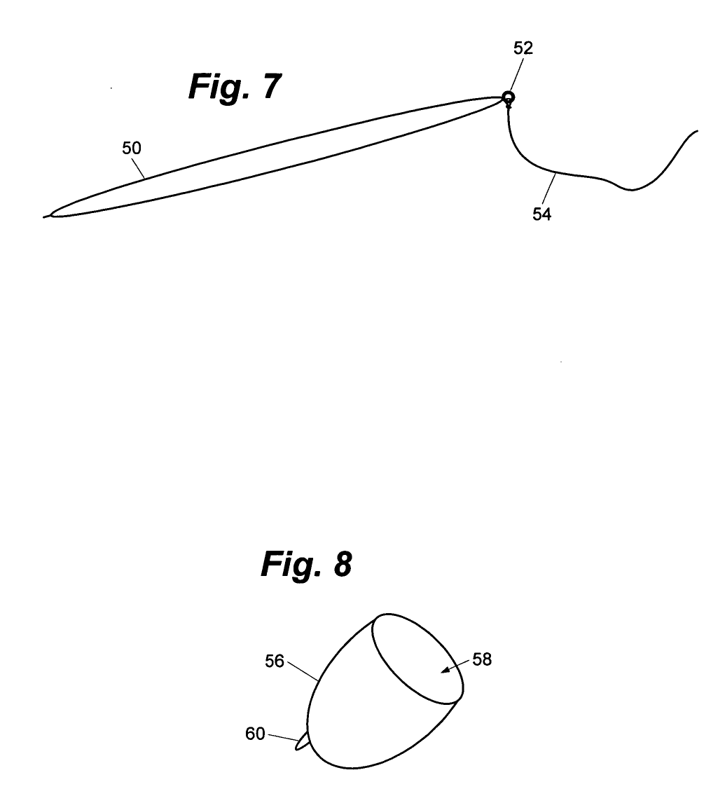

FIG. 8 shows an alternative stylus 56 that can be worn on a finger. It is particularly well suited for taking notes in which the user is constantly switching between typing and sketching. This type of stylus 56 has a opening into which the user inserts a finger. It also has a short drawing tip 60 that cooperates with the sketchpad surface and is somewhat off center so that it does not interfere with typing. Thus the user can wear the finger cap stylus 56 both when typing and sketching.

When not in use, the finger cap stylus should also have a storage area somewhere inside the notebook computer 10.

Self-contained X-Y Input Device Stylus. Still another embodiment of the invention uses the same software thus far disclosed, but relies on a stylus that is a self-contained X-Y Input Device instead of a sketch pad. Such a self-contained stylus does not require any kind of pad on the notebook computer. It operates on a table or book or any somewhat hard, flat surface near the computer. Preferably, it transmits its X-Y inputs wirelessly, but a wired version would work as well.

A self-contained stylus must detect motion on and over a surface. This can be done in many different ways. The prior art includes one that visually examines a special paper for grid line markings that reveal its X and Y location. The notes taken on this special paper can then be graphically downloaded to a computer. This stylus has a special shape so that it can only be held one way.

Another way to implement a self-contained stylus is for it to operate using a combination of visual and accelerometer methods, without requiring special paper. The stylus includes accelerometers in at least the X and Y directions. The Z direction would help it get a more clear picture of all its motion, and would allow it to calculate actual X and Y directions that are not in line with the accelerometers. Just using these accelerometers would make the stylus unusable in a moving vehicle, and would make it hard for the stylus to determine absolute motion, including holding still. Therefore, the stylus tip has a visual input that can detect the movement or lack of movement of the surface the stylus is being used on. There may be some surfaces that are too uniform, but most surface have some variations that can be detected. The stylus may also be equipped with a way of telling whether it is being held or has been put down, such as an electronic orientation device. It should also have a way of detecting contact with a surface. When a lack of movement is “seen” then the stylus knows the accelerometers should be zeroed. The accelerometers are then used to record the motions.

The above self contained stylus can also be implemented without the accelerometers, using only the visual inputs, just like an optical mouse that does not need a special mouse pad. If lighting is required, infrared light is preferred. This is the most preferred of the self-contained styluses.

A self-contained stylus and the software described herein can be sold as a package to enable use of the current invention on any existing computer, including notebook computers.

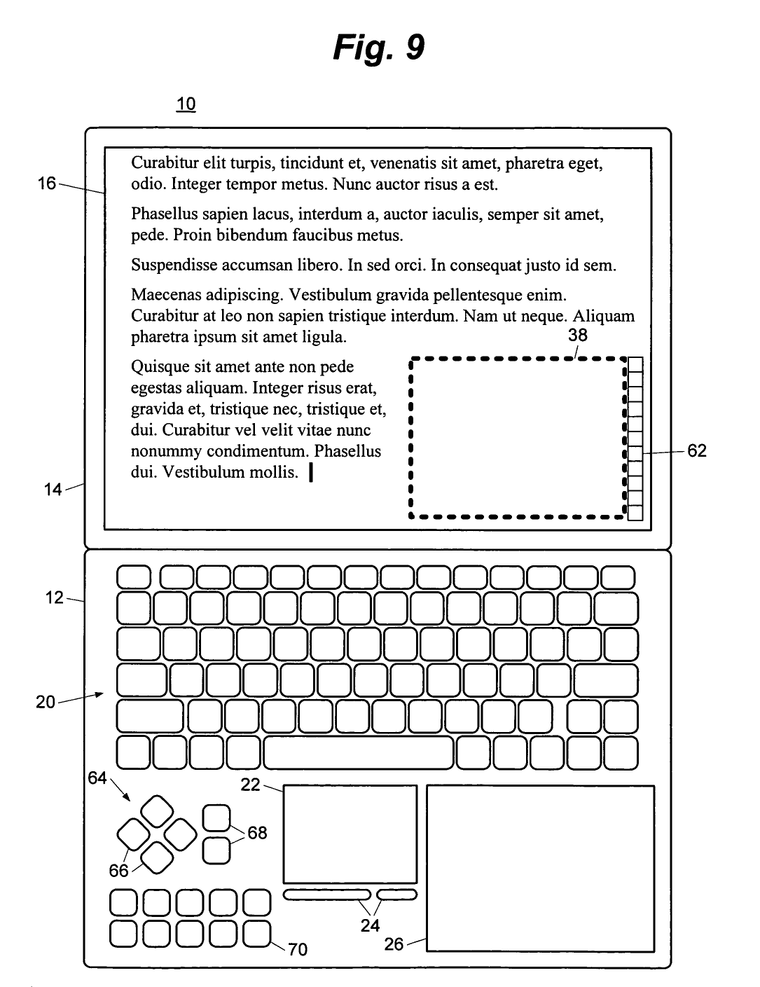

Ways of providing drawing tools. FIG. 9 shows two ways of providing drawing tools. The floating tools 62 by the frame 38 are accessible via the sketch pad 26 and shrink the sketch pad's usable area by a little bit. The floating tools 62 are shown on the right so it is in the margin, leaving the entire document a drawable area. One of the floating tools 62 may be a button that moves the entire sketch to the left, in case the user needs to add to the right side of the sketch.

To the left of the touchpad 22 in FIG. 9 are several flat buttons 64. The four diagonal panning buttons 66 control panning of the coordinate mapping frame 38 in the up, down, left and right directions. There are two zoom buttons 68 between the touchpad 22 and the panning buttons. One zooms in (making the frame 38 smaller on the document), the other zooms out (making the frame 38 larger on the document). The maximum zoom out causes the sketch pad to be mapped to the entire screen. The next-to-maximum zoom causes the sketch pad to be mapped to the entire visible portion of the document. The array of flat buttons 70 on the lower left of FIG. 9 provide functions such as pencil tool, eraser tool, floodfill tool, a few line weights, a graph paper tool (cycles through various graph papers), ink sample tool (to pick up a color from the sketch), a few colors, and a color picker (opens a window that lets the user choose any color). More or fewer buttons may be provided in different implementations of the invention.

These two ways of providing drawing tools shown in FIG. 9 are optional.

Other Notes. While rectangular sketch pads and navigation pads are preferred and shown, the rectangular shape is not an essential feature of the invention. Oval, circular or any other shape may be used for either or both pads. Whenever the drawing area is indicated on the display, the shape of the indicated drawing area should preferrably match the shape of the pad.

The preferred embodiment of the invention includes typical stylus 50 as shown in FIG. 7, as this is more natural for drawing sketches.

While the current invention has been illustrated by the description of embodiments thereof, and while the embodiments have been described in detail, it is not the intention of the application to restrict or in any way limit the scope of the appended claimed to such detail. Additional advantages and modifications will readily appear to those skilled in the art without departing from the spirit and scope of applicant's general inventive concept. Therefore the invention is not limited by the particular examples and embodiments chosen to describe it, but only by the appended claims.

I claim:

1. A portable computer comprising:
a. a display member comprising a display screen;
b. a base member operationally connected to said display member, said base member comprising a keyboard, a navigation device and a sketch means.

2. The portable computer of claim 1 wherein said sketch means comprises a sketch pad and a stylus that cooperates with said sketch pad.

3. The portable computer of claim 2 wherein said navigation device is an overlappable navigation pad and said sketch pad is an overlappable sketch pad, and a stylus, said overlappable navigation pad being sensitive to the presence and location of a finger and said overlappable sketch pad being sensitive to the presence and location of said stylus.

4. The portable computer of claim 2 wherein both said navigation device and said sketch pad are sensitive to a finger and wherein said notebook computer further comprises means for determining whether a users hand is located on the keyboard.

5. The portable computer of claim 2 wherein said navigation device and said sketch pad are integrated as a dual-sensitive touchpad, said dual sensitive touchpad being sensitive to the presence and location of a finger and said dual-sensitive touchpad being separately sensitive to the presence and location of a stylus; whereby said computer is informed of the presence and location of a finger and is separately informed of the presence and location of a stylus.

6. The portable computer of claim 2 wherein said navigation device is a touchpad and wherein said sketch pad and said touchpad are substantially coplanar to each other and said sketchpad is at least 50% larger in sensitive area than said touchpad.

7. The portable computer of claim 6 wherein at least 40 % of said touchpad is overlapped by said sketchpad.

8. The portable computer of claim 7 wherein said touchpad is substantially enclosed within said sketch pad.

9. A portable computer comprising a display, a keyboard, a navigation device and a sketch means all operationally connected and said portable computer further comprising a navigation mode accessible via the navigation device, a sketch mode accessible via the sketch means, and means for switching back and forth between said navigation mode and said sketch mode.

10. A method of inputting notes into a computer having a display, a keyboard and at least one X-Y input means, said method comprising the steps of:
a. said computer preparing an electronic document for storing text and digital ink;
b. said computer displaying at least a portion of said electronic document on said display and keeping the display of the electronic document current;
c. said keyboard inputting keystrokes and said computer sending said keystrokes to said electronic document for insertion at its caret position;
d. at least one of said at least one X-Y input means inputting navigation commands and said computer sending said navigation commands to said cursor;
e. at least one of said at least one X-Y input means inputting sketch commands and in response to said sketch commands drawing said sketch command on said display in digital ink;
f. determining whether said digital ink interferes with the text and when it does interfere reflowing said text so that it avoids said digital ink.
